(19) United States
(12) Patent Application Publication
(10) Pub. No.: US 2010/0207394 A1
(43) Pub. Date: Aug. 19, 2010

(54) DEVICE AND METHOD FOR UTILIZING WATER FLOW KINETIC ENERGY CONTINUOUSLY

(76) Inventor: Kwong-Keung Leung, Hong Kong (CN)

Correspondence Address: Dr. BANGER SHIA;Patent Office of Bang Shia, 102 Lindencrest Ct., Sugar Land, TX, 77479-5201, US

(21) Appl. No.: 12/444,376

(22) PCT Filed: May 28, 2008
(86) PCT No.: PCT/CN2008/001034

§ 371 Date: Apr. 3, 2009

(30) Foreign Application Priority Data
May 29, 2007 (CN) 200710074645.X

(51) Int. Cl. F03B 13/08; F03B 17/04

(52) U.S. Cl. 290/54; 415/916

(57) ABSTRACT

A device for utilizing water flow kinetic energy continuously comprises at least one water pump, at least one flume and plural hydro-generators. The water pump is employed to continuously supply water from a water supply to an upper head end of a flume, and then the water will naturally flow from the upper head end of the flume to a lower tail end to drive the plural hydro-generators disposed on the flume to generate power. The flume has a length larger than a distance between the water supply and an upper head end of the flume. The water is finally discharged to a desired position or back to the upper head end by a water pump disposed at the lower tail end of the flume.

### BACKGROUND OF THE INVENTION

1. Field of the Invention

The present invention relates to a device and a method for utilizing water flow kinetic energy continuously.

2. Description of the Prior Art

Commonly, all the existing water power stations generate power by converting potential energy into kinetic energy. The convention method for establishing a relatively high and large reservoir wastes lots of time, material resource and labor in cutting off water flow, and destroying villages and forest, etc to build dams. In addition, because of natural disasters such as earthquake or human factors, the dam is likely to break to cause immeasurable loss. Once no enough water supplies to the reservoir from the upstream or no ample rainwater falls into the reservoir, the water storage tanks of these water power stations are unable to generate power to the power consumers, thus directly affecting people's work and normal life.

In addition, all the conventional hydroelectric installations published in the patent literatures or other documents are not only cumbersome but with lower power supply benefit.

The present invention has arisen to mitigate and/or obviate the afore-described disadvantages.

### SUMMARY OF THE INVENTION

The primary objective of the present invention is to provide a device and a method for utilizing water flow kinetic energy continuously, which can utilize a water pump to continuously supply water from a water supply in a circulation or non-circulation manner to a long oblique flume to form a natural water flow in the oblique flume to drive plural hydro-generators in the flume to generate power or drive other machineries to work, and subsequently the water will be supplied to a desired position or discharged by another water pump disposed at a lower tail end of the flume for reuse, thus saving energy and improving the power supply benefit.

In order to achieve the above objective, a device for utilizing water flow kinetic energy continuously essentially comprises at least one water pump, at least one flume and plural continuous hydro-generators disposed on the flume. The device can be applied in such a manner that, for example, 1. producing a circular oblique concrete flume with a length of 1500000 meters, a width of 0.22 meters and a height of 2 meters on a desired position; 2. installing 500000 sets of hydro-generators on the flume with an interval of 0.2 meters; and 3. disposing a water pump or any other forms of water pump between the upper head end and the lower tail end of the flume. The above device can be operated with the following steps: 1. first disposing flume with the height difference of the upper head end and the lower tail end being 2 meters, namely shorter than the length of the circular flume, so that when the water is gradually supplied to the upper head end of the flume from an external water supply to allow the water to flow naturally along the flume to drive the respective hydro-generators to generate power until there is enough water to be discharged back to the upper head end of the flume through the drainage pipe of the water pump to substitute for the external water supply. Since the water pump can discharge the water from the lower tail end of the flume to the upper head end of the flume, the upper head end of the flume can be supplied with enough water to make the water flow up down circularly without the external water supply, so that a water supply control means is provided to stop injecting water into the flume or not. If the water in the flume is reduced by natural evaporation or accident leakage, the water supply control means can be used to fill water into the fume to maintain the normal operation. The water supplied to the upper head end of the flume is higher than the upper head end of the flume and can be the water from the sea, river, ground or the reservoir. In addition, the water pump can be driven by various fuel engines to supply the liquid from the position lower than the upper head end of the flume to the upper head end of the flume, such as the water from the sea, river, ground, water pool, reservoir, etc. During the process of injecting the liquid into the upper head end of the flume, the liquid will naturally flow from the upper head end of the flume to the lower tail end of the flume, namely the well disposed at the lower tail end of the flume. The liquid will flow along the flume with the length of 1500000 meters to the lower tail end of the flume to drive the 500000 sets of hydro-generators to generate power successively. The power generated by the 500000 sets of hydro-generators can be supplied to lots of electric products by the power network or other means, and in addition, a small part of the power can also be used to drive the water pump at the lower tail end of the flume to recycle the water. With the help of the water pump, the liquid can be fully discharged from the lower tail end of the flume back to the upper head end of the flume, so that although there is no liquid supplying from the external water supply, the liquid can be continuously supplied to the flume in a circulation manner to drive the 500000 sets of hydro-generators that are disposed in the flume with the length of 1500000 meters to generate power continuously. Using water pump to recycle the water to maintain a continuous water flow in a long oblique/non-oblique flume to obtain power greater than the power consumed by the water pump is the innovative technical feature of the present invention.

In the device of the present invention, the length of the flume is not limited to 1500 kilometers, and the number of the hydro-generators disposed on the flume is not limited to 500000, the width of the flume is not limited to 0.22 meters, and the hydro-generators are sized according to the actual requirements, the depth of the liquid in the tank in contact with the blades of the hydro-generators is not limited to 0.05 meters. In addition, the height difference of the upper head end and the lower tail end of the flume can be determined according to the actual requirements, such as 2 meters, more than 2 meters, or less than 2 meters.

The device and method for utilizing water flow kinetic energy continuously of the present invention are simple and convenient to use and can solve the technical problem that the hydro-generator cannot work when no water is supplied from the upstream. The device and method of the present invention can cooperate with the existing power transmission network to transmit by the generated power to the desired positions. In addition, the device for utilizing water flow kinetic energy continuously can be widely combined at both sides of the railway and the road or in various traffic and transportation means such as vehicles, ships, etc. The device for utilizing water flow kinetic energy continuously can also be combined with various electric products. Further, the present invention can also be applied to any proper occasions such as the sea, riverbed, reservoir, river, water tank, water pool, water tower, mountain, etc, so as to obtain the desired kinetic energy and power.

### BRIEF DESCRIPTION OF THE DRAWINGS

FIG. 1 is a perspective view of a first hydroelectric installation in accordance with the present invention;

FIG. 1A illustrates that the hydroelectric installation is provided with an electric helical water pump in the well at the lower tail end of the flume;

FIG. 1B is an operational view of the hydroelectric installation of FIG. 1A;

FIG. 1C is a schematic view of a filter and a protecting mesh in accordance with the present invention;

FIG. 2 is a perspective view of a second hydroelectric installation in accordance with the present invention;

FIG. 3 is a perspective view of a third hydroelectric installation in accordance with the present invention;

FIG. 3A is a perspective view of a circular flume in accordance with the present invention;

FIG. 3B is a schematic view illustrating that another water pump of the circular flume is used to keep the hydro-generators generating power;

FIG. 4 is a perspective view of a fourth hydroelectric installation in accordance with the present invention;

FIG. 5 is a perspective view of a fifth hydroelectric installation in accordance with the present invention;

FIG. 6 illustrates some of the components of the device for utilizing the water flow kinetic energy continuously in accordance with the present invention;

FIG. 6A is a perspective view of one of the waterwheels of the hydroelectric installation in accordance with the present invention;

FIG. 6B is a perspective view illustrating that a vertical flume is installed with a waterwheel in accordance with the present invention;

FIG. 6C is a perspective view of another waterwheel in accordance with the present invention;

FIG. 6D is a perspective view of another hydro-generator which is installed in the flume of the hydroelectric installation in accordance with the present invention;

FIG. 6E is a schematic view illustrating that how another waterwheel in accordance with the present invention drives other machineries;

FIG. 7 illustrates some components of the device for utilizing water flow kinetic energy continuously in accordance with the present invention;

FIG. 7A is a schematic view of another combination of flume and waterwheel in accordance with the present invention;

FIG. 7B is a schematic view of another combination of flume and waterwheel in accordance with the present invention;

FIG. 7C is a schematic view of another combination of flume and shelled waterwheel in accordance with the present invention;

FIG. 7D is a schematic view of another combination of flume and waterwheel in accordance with the present invention;

FIG. 7E is a schematic view of another combination of flume and hydro-generator in accordance with the present invention;

FIG. 7F is a schematic view of another combination of shaft and blades of a horizontal waterwheel in accordance with the present invention;

FIG. 7G is a schematic view of another combination of shaft and blades of a vertical waterwheel in accordance with the present invention;

FIG. 7H is a schematic view of another combination of shaft, frame and blades of a vertical waterwheel in accordance with the present invention;

FIG. 7I is a schematic view of another combination of shaft, frame and blades of a vertical waterwheel in accordance with the present invention;

FIG. 8 illustrates some components of the device for utilizing water flow kinetic energy continuously in accordance with the present invention;

FIG. 8A illustrating one combination of drainage elements for a water pump in accordance with the present invention;

FIG. 8B is a schematic view illustrating a switch controller in accordance with the present invention; and

FIG. 9 is a schematic view of another device for utilizing water flow kinetic energy continuously in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

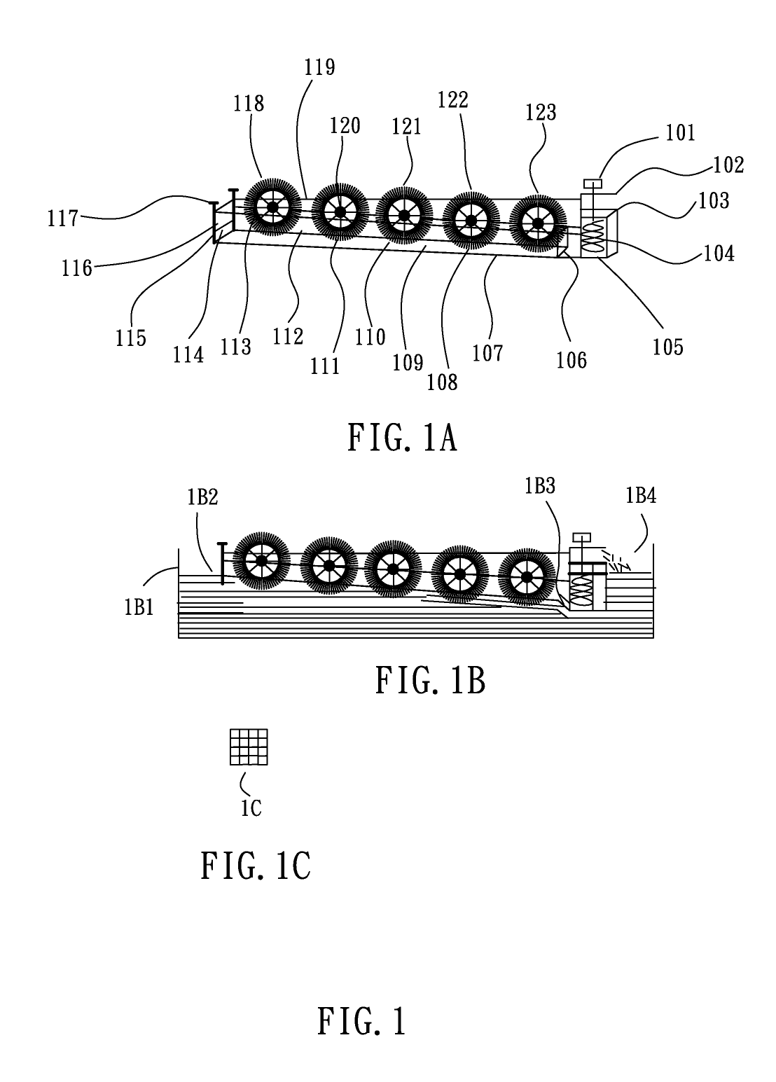

FIG. 1 shows a hydroelectric installation in accordance with a first embodiment of the present invention, and the fundamental structure technical features of the present invention comprises: 1. a drain device includes powered water pumps and power supply switch control equipments, etc, such as the powered helical water pump 101 (as shown in FIG. 1A) which are disposed at a tail end of the flume; 2. flume containers are open-type flumes 105, 107; and 3. multiple power generating units 108, 123, 109, 122, 110, 121, 111, 120, 112, 118 and various facilities with respect to the above respective devices.

The water pump 101 has a motor to drive the water pump 104 including a helical waterwheel, which is disposed in the flume 105 to discharge the water from the well of the flume 105 out of the flume 105 through the drainage pipe exit 102, and drive the water outside the flume 105 to continually flow into the well of the flume 105 through the flumes 107, 106 to drive the respective waterwheel power generating units in the flume to generate power. As for such a hydroelectric installation, besides the helical water pump 104, it can also employ a centrifugal water pump and a variety of drainage tools to discharge water.

In the present embodiment, the water passage through which the water is discharged out of the flume 105 can be designed to be a circulation type to discharge the water into the flume 114 for a direct circulation use or into an external storage container for an indirection circulation use, and certainly, it can also be designed to discharge the water to other required positions, for example, when the flume of the hydroelectric installation of the present invention is disposed in a water pool, a reservoir, a river or the sea, the water discharged by the water pump can be directly discharged into the water pool, reservoir, river or seat which is connected to the hydroelectric installation of the present invention for direct or indirect circulation use.

In such an embodiment, the flume, the water pump installed on the flume, the hydroelectric installation, etc can be designed with an encircling slantwise or bending channel to discharge the water out of the flumes, otherwise, they can also be designed with step-by-step interlocking channels, layer-upon layer single, multiple, circulation, non-circulation or mixed channels. For example, when the first-line flume is disposed in the riverbed, the second-line flume can be disposed at the positions other than the riverbed, and similarly, the third-line flume and other flumes can be disposed in the same manner. The above flumes can be operated in such a manner that, for example, when the water pump which is disposed at the lower tail end of the first-line flume is turned on to discharge the water into the higher second-line flume, the respective hydro-turbine generators that are disposed on the first-line and second-line flumes will be driven by the water flow to generate power. Similarly, the water pump which is disposed at the lower tail end of the second-line flume, namely at the a position lower than the headstream of the second-line flume, so that the water pump can discharge the water that naturally flows from the headstream to the lower tail end of the second-line flume into the higher headstream of the third-line flume. Since the water continuously flows from the headstream of the third-line flume to the lower tail end of the third-line flume, the water flow can drive a series of waterwheels disposed on the flume to output energy such as generating power, etc. Therefore, the final water can be discharged from the lower tail end of the flume to the desired position such as the droughty area or the unwatered reservoir, etc or back to the headstream of the entire device so as to be directly or indirectly recycled. If the flume is disposed in the sea where the water level varies frequently or other unstable riverbed, the flume can be designed capable of ascending and descending and cooperate with many related equipments. In the present embodiment, the headstream of the first-line flume can be alternatively disposed above the water surface of the river or sea, so that the water pump can be used to supply the sea water or river water to the flume.

The flume 105 includes a shell 103 employed to prevent the improper backward flow of the water which is discharged or located outside the flume 105.

The helical cylindrical drainage device 104 that is driven by motor is employed to discharge the water out of the flume 105.

The open-type flume 105 which is provided with the water pump is obviously lower than the flume which is installed with the turbine generators.

The flume 106 which is installed with the turbine generator includes a flume entry 114 and a flume exit which is located close to the flume 105. There is a height difference between the flume entry 114 and the flume exit, namely the flume entry 114 is higher than the flume exit and the flume 105, so that the water entering the flume exit 114 can naturally flow into the water pump of the flume 105. In addition, the flume 106 can be designed in such a manner that the flume entry 114 and the tan exit of the flume 106 are located on the same horizontal line, or in a closed oblique form, so as to cooperate with an erect or horizontal hydro-generators.

The open type flume 107 of the present invention can be sized as desired and made of any proper material such as concrete, metal, nonmetal, etc. In addition, the flume 107 can be in any form such as encircling form or non-encircling form. The flume 107 can be further provided with plural turbine generators and plural water pumps, so that when the flume 107 is disposed in a man-made river or a natural river, it can make the water continuously flow to make the turbines disposed in the flume 107 to output kinetic energy, thus driving the generators to generate power.

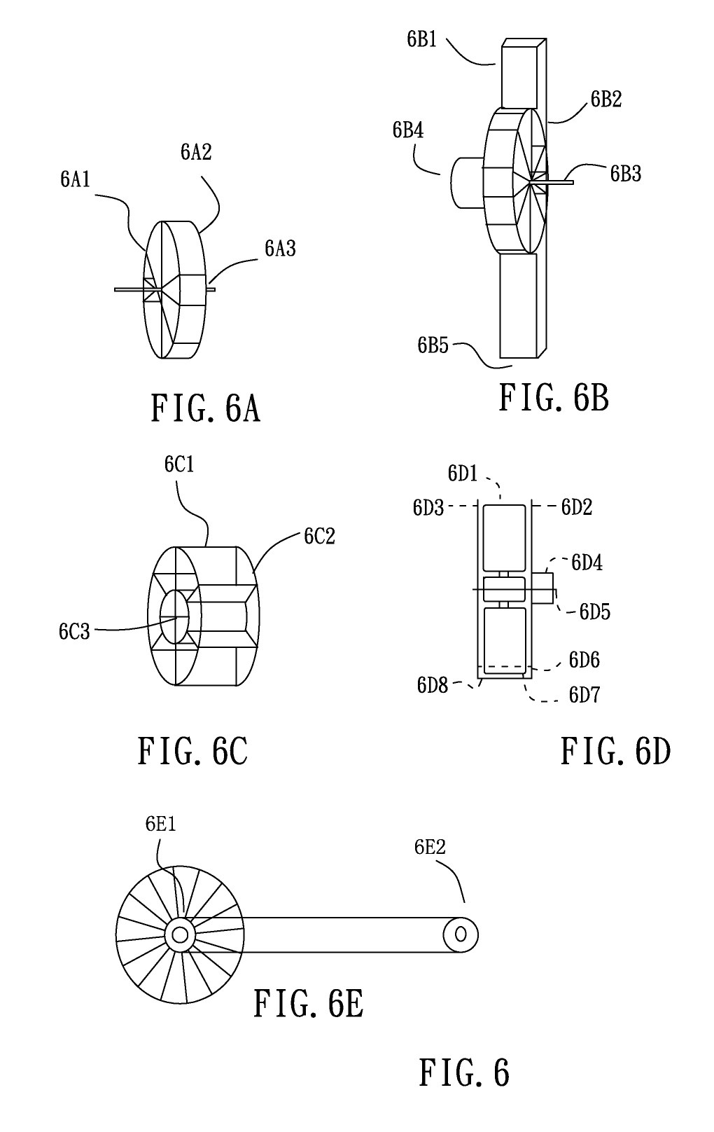

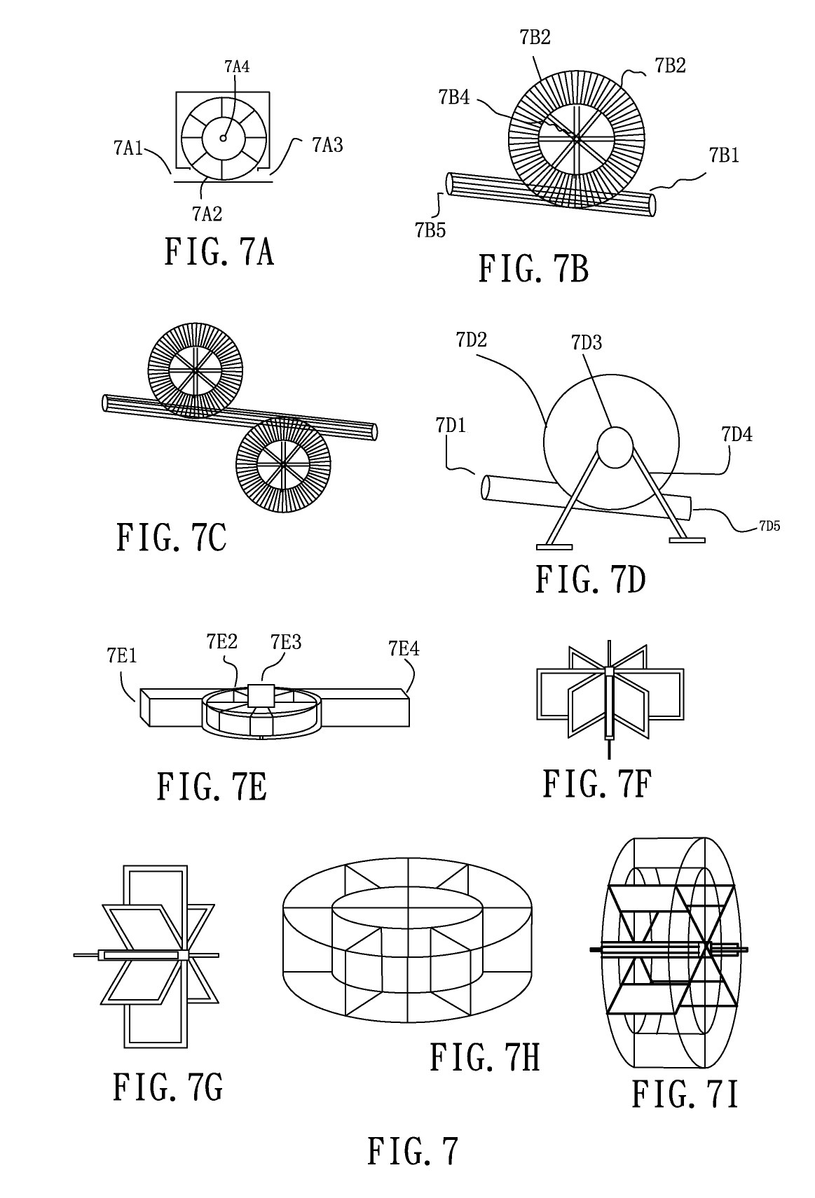

Five of the waterwheel assemblies 108, 109, 110, 111, 112 that are disposed in the flume can also be produced in the forms shown in FIGS. 6A, 6C, 6D, 6E, 7A, 7G, 7I or other forms that can directly or indirectly drive the power generators to generate power.

According to the requirements of the flume, the present invention can employ a horizontal, flexor, etc type of waterwheel assemblies.

Five independent power generators 118, 120, 121, 122, 123 are located in the same flume and driven by turbine assemblies. According to the requirements, the present invention can be provided with 300, more than 300 or less than 300 hydro-generators that are disposed on the flume and driven by the water flow.

The transparent shell 113 located at both sides of the flume can be made of metal, concrete or other proper materials.

The water is injected into the flume through the flume entry 114.

The controller 117 is employed to control the water gate.

The power generators or other equipments are driven by the turbine assemblies through belt, chain, gear, shaft transmission, etc. The turbine assemblies are integral with or separate from the power generators or other equipments.

The shell 119 located at both sides of the flume is transparent.

FIG. 1B is an operational view of the hydroelectric installation of FIG. 1A. Firstly, a pre-produced flume made of metal or other proper materials, and plural hydro-generators, water pumps or other mechanical equipments that are disposed on the flume are installed outside a pool in such a manner that the water level of the pool is higher than the flume entry 1B1 of the flume. Next, the flume gate 1B2 will be opened to allow the water to flow into the flume 1B3 gradually. After that, the water will flow from up to down in the flume 1B3 to drive the respective hydro-generators to generate power for outputting power outwards or activating other mechanical operations including power storage operation. For example, the power can be supplied to the water pump 1B4, so that the water pump 1B4 can be actuated to discharge the water out of the flume in time from the lower tail end of the flume to keep the water flowing endlessly in the flume, such as discharging the water back into the pool to recycle the water to drive the respective hydro-generators in the flume to output power to the power consumers or the water pump.

The container capable of providing a proper amount of water to the flume of the present invention to keep the water pump or other drainage equipments discharging water can be disposed on a pool, and it can also be selectively disposed on a reservoir, a water tank, a lake, a river, the sea, the land, etc.

As shown in FIG. 1B, the water pump can also discharge the water out of the flume in a non-circular manner, for example, the water in the reservoir can be discharged by the water pump to the upstream or downstream of the reservoir through the drainage channel of the water pump to recycle the water directly or indirectly to generate power.

Besides stainless steel, the gate 116 can also be made of concrete or other proper materials.

FIG. 1C illustrates a filter and a protecting mesh. The filter can be disposed at the flume entry to prevent the fishes or other undesired objects from entering the flume through the flume entry. The protecting device of the filter and other forms of protecting devices can further be applied to protect the turbine assemblies and power generators. Besides the protecting net, the present invention can also be provided with a shell-like element to protect its entire elements.

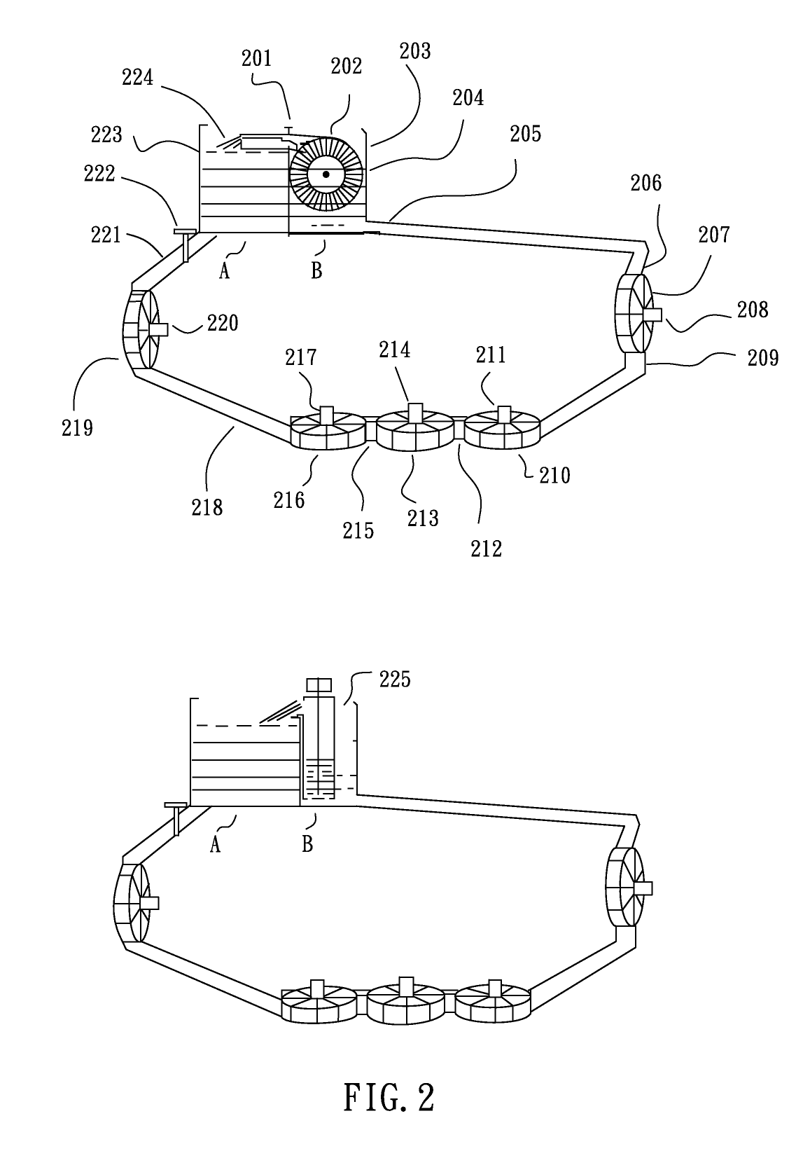

FIG. 2 illustrates a hydroelectric installation in accordance with a second embodiment of the present invention. The main technical features of the present embodiment include: a liquid container 201 divided into two containers A and B by a divider, pipes 221, 205 employed to supply a proper liquid to the container B from the container A, the respective hydro-generators 220, 219, 217, 216, 214, 213, 211, 210, 208, 207 that are disposed on the pipe, a water pump 202 disposed in the container B and its power switch, etc. The containers and water pipes in the present embodiment can be made of metal or other various proper materials such as plastic, concrete, etc. The operation steps of the hydroelectric installation in the present embodiment can be operated in two methods: a.: firstly, closing the drainage valve 222 on the pipe of the container A; and then filling water into the container A until the water reaches the water level 223; after that, opening the drainage valve 222 to make the water in the container A naturally flow into the container B in which the water lever 204 is lower than the water level 223 of the container A and the water pump is running, and finally stopping filling external water into the container A; and b. : firstly, injecting water into the container A, the container B and the drainage pipe provided with the hydro-generators of the present embodiment until the water reaches the water levers 204 and 203, respectively, and then actuating the water pump 202 to discharge the water in the container B into the container A for reuse. Since the water pump continuously discharges the water in the container B into the container A, the water lever of the container A will be higher than that of the container B, thus forming a water level difference therebetween, which causes the water to naturally flow from the container A to the container B. Therefore, when the water flows through the drainage pipe 221, the waterwheel 219 will be pushed to drive the generator 220 to generate power, when the water flows through the drainage pipe 218, the waterwheel 216 will be pushed to drive the generator 217 to generate power, when the water flows through the drainage pipe 215, the waterwheel 213 will be pushed to drive the generator 214 to generate power, when the water flows through the drainage pipe 212, the waterwheel machine 210 will be pushed to drive the generator 211 to generate power, when the water flows through the drainage pipe 209, the waterwheel machine 207 will be pushed to drive the generator 208 to generate power, and finally, the water will flow into the container B though the water pipes 206 and 205 and then be discharged by the water pump for reuse. The containers A and B both are open or non-open, in addition, they can be made in a joined or separate manner. Of course, a container can be made into various devices with or without a cover. Another water pump 225 of the hydroelectric installation in the present embodiment of the present invention is of the same type as the water pump 520 and can substitute for the water pump 202. As shown in FIG. 2, the containers A and B can also be made into circular type system by drainage pipes in such a manner that the two containers A, B are divided into by a certain space and connected through drainage pipes. The containers A, B can be provided with communicating water pipes having a switch control device on the bottom thereof. The water level difference between the two containers A, B can be determined as desired, such as 0.5 meters, 1 meter, 3 meters, 300 meters, etc. The size, length and the number of the hydro-generators of the containers and the drainage pipes in the present embodiment are determined according to the actual requirements. The amount of drainage of the drainage pipe of the containers in the present embodiment changes according to the actual requirements. The drainage means and the motor in the water pump can be of a split type or not, such as a motor installed outside the water of the container drives the drainage turbine located in the water through a belt to discharge the water. The containers A and B in the present embodiment can be made into various devices like flume. In the hydroelectric installation of the present embodiment, in addition that the turbines are directly used to drive the generators to generate power, the turbines can drive the generators outside the turbine shell through shaft, belt, gear, etc to generate power to actuate other mechanical works.

The water pump in the present embodiment can be powered by both an external power supply and the hydro-generators disposed on the drainage pipe of the present invention, including an accumulator. For example, as shown in FIG. 2, the containers can be provided with an automatic water supply device to keep the water capacity stable.

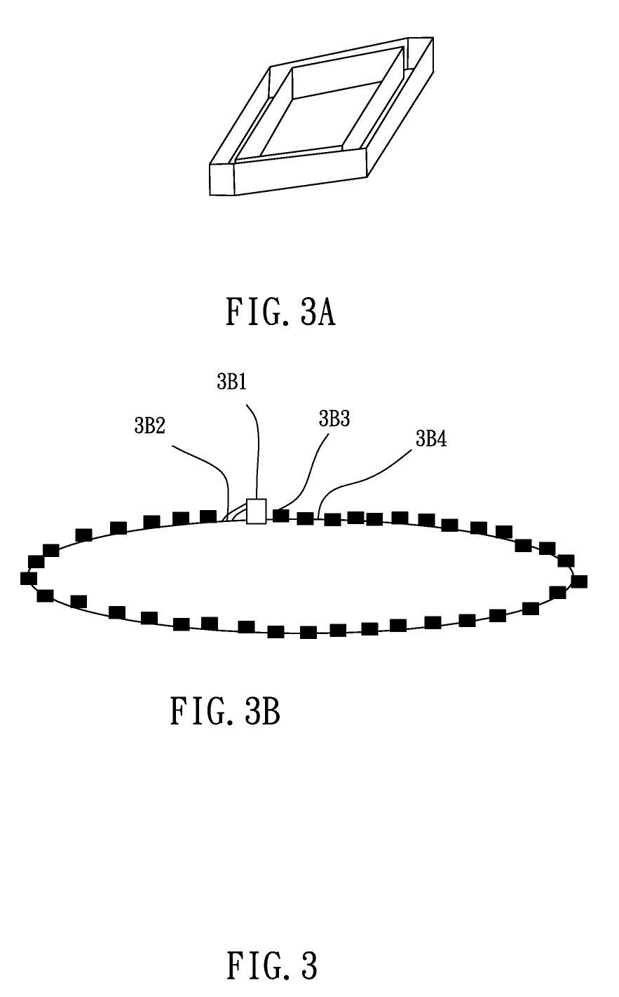

FIG. 3A is a schematic view of one of the circular type flumes of the water pump. Besides the form shown in FIG. 3A, the circular flume can also be in the bending, circular, screw, line, extension forms. The circular flume can be an open channel with the length of 2 kilometers, and it can also be a closed channel. The method for using the water flow of the flume to generate power has a first feature: the flume is divided into two spaces at an arbitrary position by means of a proper divider higher than the water lever of the flume such as a clapboard, brick wall, etc, wherein one of the two spaces is called a upper head end, and the other space is called a lower tail end. 300, and more than 300 or less than 300 hydro-generators are disposed along the flume. The flume can cooperate with the hydro-generator in the manner as shown in FIG. 6A, 6B, 6C, 6D, 6E, 7A, 7B, 7C, 7D, 7E, 7F, 7G, 7H, or 7I. In addition, the power can also be generated by the winding flume cooperating with centrifugal turbines and other forms of waterwheels. At the lower tail end of the flume is disposed a water pump. There is a water level difference between the upper head end and the lower tail end of the flume, such as the water level of the headstream is higher than that of the lower tail end, and the water level difference is about 5 centimeters but not limed to 5 centimeters. In addition, the lower tail end of the flume is provided with a well lower than the flume at a position where the water pump is located, so that the water pump can be used to discharge the water at the lower tail end to the upper head end of the flume for reuse. Since the water level of the upper head end of the flume is higher than that of the lower tail end of the flume, the water can naturally flow from the upper head end to the lower tail end of the flume and finally discharged back to the upper head end by the water pump to keep the water flowing continuously in the flume to drive the respective hydro-generators disposed on the flume to generate power. The method for using the water flow of the flume to generate power has a second feature: the flume can be divided into a upper head end and a lower tail end at an arbitrary position by a proper divider such as a clapboard, a brick wall, etc, and in the flume is provided plural hydro-generators, and at the lower tail end of the flume is disposed a water pump. There is no water level difference between the upper head end and the lower tail end of the flume, and but when the water pump is used to assist discharge the water from the lower tail end into the upper head end, the water level of the upper head end will be suddenly higher than that of the upper head end, so that the water will naturally flow from the upper head end to the lower tail end and then be discharged backed into the upper head end by the water pump, thus keeping the water continuing flowing in the flume, which can drive the respective hydro-generators to generate power. The flume or various liquid containers in the present embodiment can be made with a mouth diameter of 5 square centimeters, or 5 square meters but limited to 5 square centimeters and 5 square meters, and a length of 50000 meters, but not limited to 50000 meters. The number of the hydro-generators disposed on the flume can be 150000, more than 150000 or less than 150000. The number of the water pumps that are disposed at the tail portion of the flume can be 1 but not limited to 1.

FIG. 3B is a schematic view of another water pump which is disposed on a circular water passage to maintain the hydro-generators generating power, 3B1 represents a divider disposed in the water passage to divide the passage into a head and lower tail ends, 3B2 represents a water pump employed to discharge the water from the lower tail end into the upper head end to maintain the water continuing flowing in the water passage to drive the respective hydro-generators disposed in the water passage to generate power, 3B3 represents one of the hydro-generators disposed in the water passage, and 3B4 represents a part of the circular water passage. The system of a water pump cooperating with a circular water passage to drive hydro-generators to generate power can be built on various buildings and the ground or under the ground or in the river, etc. In addition, this system of the present invention can further cooperate with various electric equipments such as computer, calculator, power transmission network, etc.

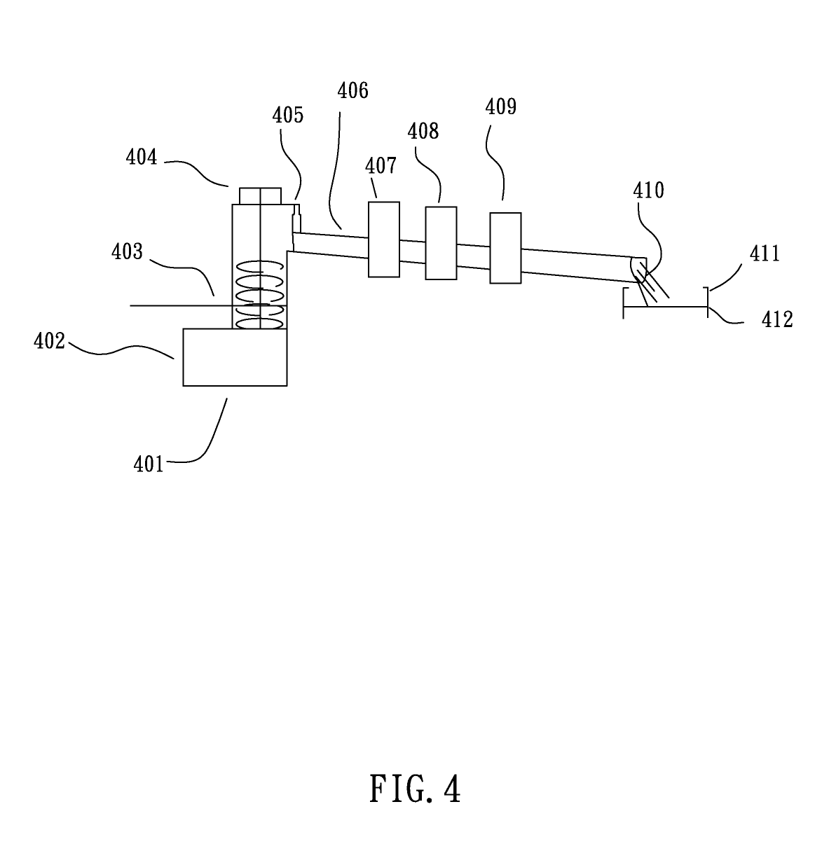

Referring to FIG. 4 a hydroelectric installation in accordance with a third embodiment of the present invention comprises a liquid drainage passage defined by a water tank 405, a drainage passage 406, a flume outlet 410, etc, a suction pipe 401 and a suction inlet 402 of an electric water pump that is installed on a riverbed or in the sea, and plural hydro-generators 407, 408, 409 that are installed on an oblique flume. Further, the reference number 403 in FIG. 4 represents the water level 403 of the suction pipe. The operation method of the hydroelectric installation in the present embodiment comprises the steps of: firstly, actuating a water pump 404 by means of external power to pump water from the river or sea into the drainage passage 406 of the container through the suction inlet 402, and then the water will flow along the drainage passage 406 downwards and finally out of the flume outlet 410 into the desired positions such as reservoir 411, man-made channel or natural channel 412, etch. While the water flows continuously along the flume, the hydro-generators 407, 408, 409 that are disposed on the flume can be driven by the water flow to generate power. The flume outlet 410 in the present embodiment can be provided with another water tank 405 which is further connected to another oblique water drainage passage 406 to utilize the water flow from up downwards to drive another group of hydro-generators to generate power, so that the hydroelectric installation in the present embodiment of the present invention can be provided with 300 groups of hydro-generators (not limited to 300 groups) in the same manner to generate power or actuate other mechanical operations, and the water is also finally discharged to the desired position or back to the headstream for reuse. The length of the drainage 406 is larger than the height of the water pumped from the riverbed, sea or any water supply to the drainage passage 406 of the water tank 405 through the suction inlet 402. The drainage passage 406 can be made into an open type, close type or partially-open type configuration. The hydroelectric installation in FIG. 4 can work independently or be connected to the installation in FIG. 1 in a series operation manner to discharge the sea water to any areas lacking of water source such as desert, and it can also be connected to other installation shown in other drawings to solve the problems of water shortage and power supply.

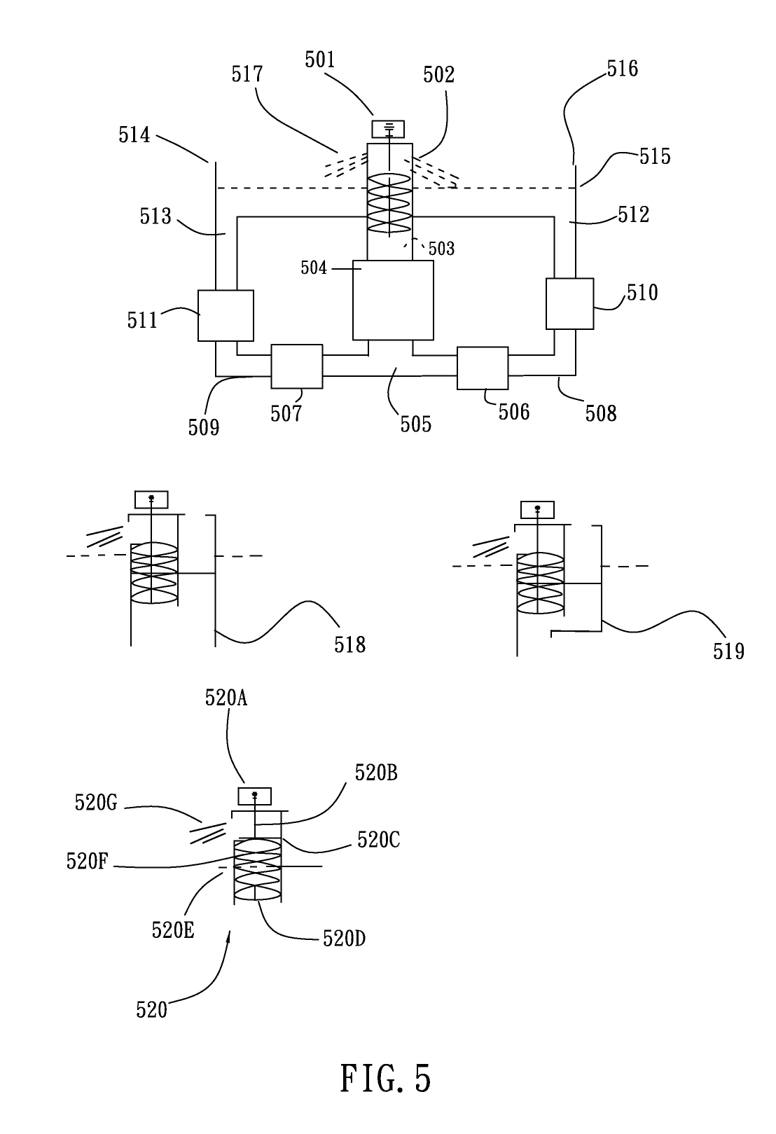

Further referring to FIG. 5, a hydroelectric installation in accordance with a fourth embodiment of the present invention comprises plural liquid circulation passages 203, 505, 508, 509, 512, 513, two containers 514, 516, liquid circulation hydro-generators 504, 506, 507, 510, 511, and a water pump 501 that is disposed on the overall liquid circulation passage. The flume of the water pump 501 has a proper ventilating space, and the water pump 501 is in a proper proportion to the water pumps 518, 519, and they can adjust the drainage speed to control the drainage of the flume. The flume and the respective elements of the present invention can be of branched type or composite type to pump and discharge liquid to make the hydro-generation methods and devices multiple. The method for operating the hydroelectric installation of the present embodiment comprises the steps of: firstly, injecting the liquid in the flume 503 until the liquid reaches the water level 515, and then actuating the water pump 501 to discharge liquid, since the liquid pumped by the water pump 501 from the flume 503 is discharged above the water level 515 of the original flume 503, such as water level 502, 517 and then into the flume 503, the flume 503 will be formed with an invisible space, so that the liquid in the hydro-generator 504 can naturally flow into the invisible space of the flume 503, subsequently, the hydro-generator 504 will be formed with an invisible space, so that the liquid in the flume 505 will naturally flow into the invisible space of the hydro-generator 504 to drive the hydro-generator 504 to generate power, and next, since the original liquid of the flume 505 flows to fill in the space of the hydro-generator 504, the flume 505 will be formed with a space, so that the liquid in the hydro-generators 506, 507 will also naturally flow into the space of the flume 505 synchronously, and thus the hydro-generators 506, 507 will be formed with spaces, and then the water will naturally flow to fill in the spaces of the hydro-generators 506, 507 to drive the hydro-generators 506, 507 to generate power. Similarly, the hydro-generators 510, 511 can be driven by the water flowing from the flumes 508, 509 to the flumes 512, 513 to generate power. The liquid is discharged by the water pump 501 from up down to realize the liquid circulation in the flume. The water pump continuously recycles the liquid in the flume to keep the liquid in the flume continuing flowing to drive the respective hydro-generators 504, 506, 507, 510, 511 to generate power.

The water pump 520 in the hydroelectric installation in the present embodiment includes a motor 520A with a power switch controller, a shaft 520B driven by the motor to drive a helical blade 520F, a shell 520C of the helical blade 520F, a liquid inlet 520D and an liquid outlet 520G

Referring to FIG. 6A, one of the waterwheels of the hydroelectric installation in the present embodiment of the present invention includes plural blades 6A1, a frame 6A2 and a shaft 6A3.

Referring to FIG. 6B, a vertical flume with a waterwheel includes an ingoing channel 6B1, a flume 6B5, a shell 6B2, a shaft 6B3 and a motor 6B4.

Referring to FIG. 6C, another waterwheel in accordance with the present invention includes plural blades 6C1, a frame 6C2 enclosing the blades 6C, and a shaft 6C3.

Referring to FIG. 6D, another hydro-generator in accordance with the present invention which is disposed in the flume includes plural blades 6D1, 6D7, 6D6, two side flume shells 6D2 and 6D3 holding the hydro-generator, a generator 6D4 driven by a waterwheel to generate power, and a waterwheel shaft 6D5. 6D8 represents a bottom line of the flume in FIG. 6D.

Referring to FIG. 6E, another waterwheel 6E1 in the hydroelectric installation accordance with the present invention drives the generator to generate power or other equipments to work by means of various transmission belts, chains 6E2, etc.

Referring to FIG. 7A, another combination of flume and waterwheel in accordance with the present invention includes a square or other forms of shell, water passages 7A1 and 7A3 of the flume through which the water will flow to drive the blades of the hydro-generators to generate power, plural blades 7A2 of the waterwheel and a shaft 7A4 of the waterwheel 7A4 employed to drive the shafts of other equipments.

Referring to FIG. 7B, another combination of flume and waterwheel in accordance with the present invention includes a circle or other forms of shell, a flume inlet 7B1, plural waterwheel blades 7B2, a waterwheel shell 7B3, a waterwheel frame 7B4 connected to the shaft of the waterwheel, a flume outlet 7B5.

Referring to FIG. 7C, another combination of flume and waterwheel in accordance with the present invention includes a turbine having a shell.

Referring to FIG. 7D, another combination of flume and waterwheel in accordance with the present invention a flume inlet 7D1, a flume outlet 7D2, a waterwheel shell 7D2, a waterwheel 7D3, a frame 7D4 supporting the waterwheel and the generator.

Referring to FIG. 7E, another combination of flume and waterwheel in accordance with the present invention is horizontally arranged and includes a water inlet pipe 7E1, a water outlet pipe 7E2, a transparent shell 7E2 enclosing the waterwheel blades and frame, etc, and a hydro-generator set 7E3.

Referring to FIG. 7F illustrating another combination of blade and shaft of a horizontal waterwheel, the shape and number of the blades can be determined as desired, such as the number of the blades can be 9, more than 9 or less than 9, and the blades can be in the helical or other proper forms.

FIG. 7G is another combination of blade and shaft of a vertical waterwheel in accordance with the present invention.

Referring to FIG. 7H illustrating another combination of blade, shaft and frame of a waterwheel in accordance with the present invention which can be of horizontal type, vertical type or other types, the shaft is hollow centrifugal element and can be connected to the surrounding blades by the frame.

Referring to FIG. 7I illustrating another combination of blade, shaft and frame of a waterwheel in accordance with the present invention, the shaft is hollow and can be connected to the surrounding blades by the frame.

Besides the above combination of forward-flow or backward-flow types of flume and waterwheel, other winding types of flume and various associated waterwheels are also within the scope of the present invention.

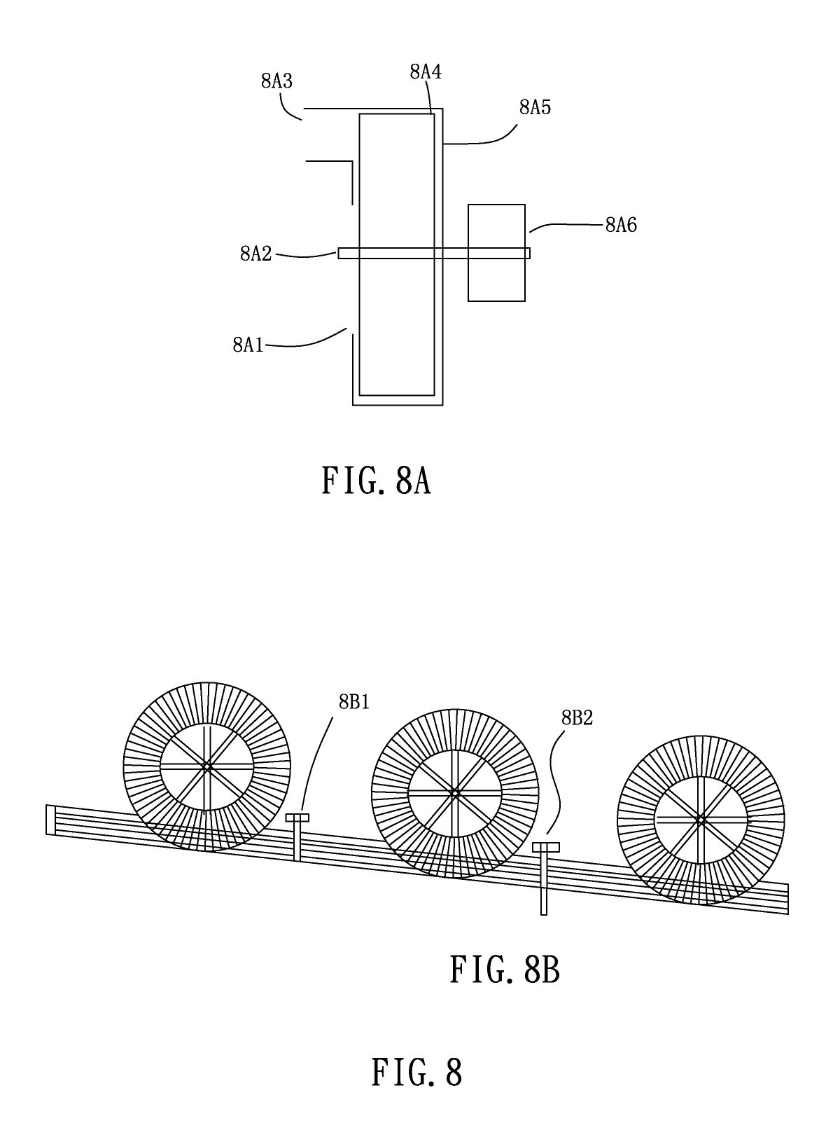

Referring to FIG. 8A illustrating one combination of drainage elements for a water pump, 8A1 illustrates that some blades of the water pump are disposed in the liquid of the flume, 8A2 represents the transmission shaft of the electrical water pump, 8A3 represents the drainage route of the water pump through which the water is discharged by the water pump from up down, 8A4 represents some of the blades of the waterwheel, 8A5 represents a shell enclosing the blades of the waterwheel of the electric water pump, and 8A6 represents a motor employed to drive the blades of the waterwheel to pump and discharge water. The motor can be disposed in or outside the flume to drive the waterwheel to pump or discharge water by means of shaft or transmission belt.

8B1 in FIG. 8B represents a switch controller employed to discharge the water out if necessary.

8B2 in FIG. 8B represents a divider employed to divide the flume for facilitating the replacement and maintenance of the flume and the waterwheel.

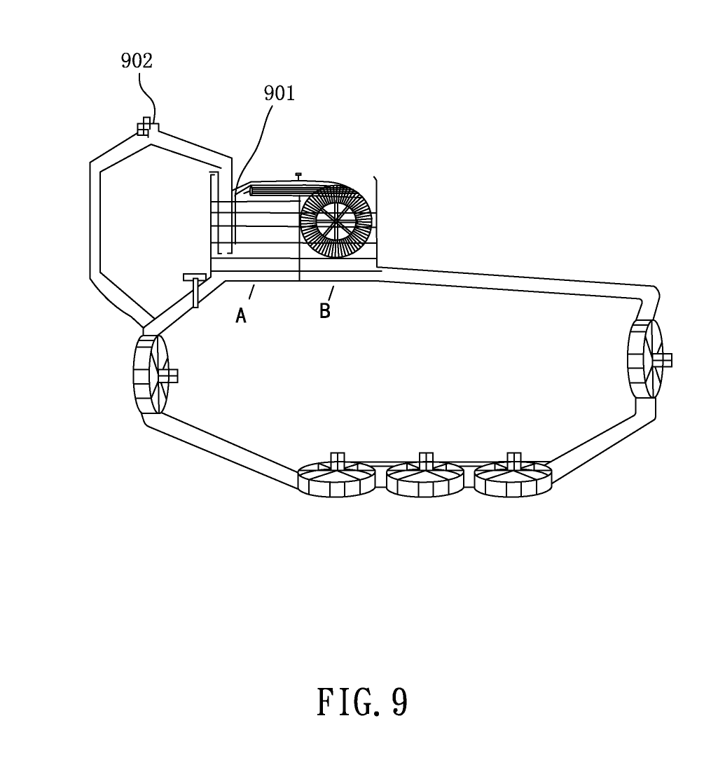

Referring to FIG. 9 illustrating another compound hydroelectric installation of the present invention, the installation in FIG. 9 is the same as the hydroelectric installation in FIG. 2 in basic structure and generation efficiency but provided with an extra siphon type flume ancillary device 901 which can round the container 9A, the water passage is provided with a valve at the pipe opening in the bottom of the container 9A, and the flume ancillary device 901 is provided with a water injection apparatus 902 and can also be installed with a multifunction device such as a water pump or a hydro-generator. The hydroelectric installation in FIG. 9 can be operated with the following steps: firstly, injecting a proper amount of liquid in the containers 9A, 9B and the circular drainage pipe such as 901, and then actuating the water pump. When the water flows through the pipe circularly, the respective hydro-generators disposed on the pipe can be driven to generate power. The flume in the hydroelectric installation of FIG. 9 can be designed into a siphon form or other proper forms.

A device and a method for utilizing water flow kinetic energy continuously in accordance with the present invention essentially comprises the following features: 1. a water pump disposed at a lower flume for separating or connecting a higher flume; 2. an oblique circular flume; and 3. 10 sets of or more continuous hydro-generators. The method for utilizing water flow kinetic energy continuously comprises the steps of: 1. injecting external liquid into the higher flume until the water flows to the lower tail end of the lower flume; 2. actuating the water pump until there is a continuous amount of liquid flowing through the water pump to discharge the liquid at the lower tail end of the flume to the higher flume; and 3. stopping supplying external water to make the liquid in the flumes flow from up down continuously to form a natural up-to-down flow, which can continuously drive the continuous hydro-generators on the flume to generate power or other equipments to work.

A device and a method for utilizing water flow kinetic energy continuously essentially comprises the following technical features: 1. a water pump capable of supplying enough liquid to all the flumes from a liquid supply to allow the water to flow from up down to drive the continuous hydro-generators on the flumes to generate power; 2. flume having a length greater than a distance between a lower liquid supply and the water pump; 3. plural sets of continuous hydro-generators disposed on the flumes. This device utilizes the water pump to supply enough liquid to all the flumes from the water supply to allow the liquid to flow from up down to drive the respective hydro-generators to generate power and finally flow to the desired area. This device not only can work independently but can also be used in any proper environments such as power generation plant, power system, electric equipments, reservoir, riverbed, the sea, water channel, water passage, traffic transportation means, etc. In order to make the hydroelectric installation of the present invention applicable in a cold environment, the device for utilizing water flow kinetic energy continuously can be further provided with a direct or indirect electric warming equipment or other different equipments such as a thermostatic electronic heat retainer, or added with solvent for preventing the liquid from solidifying, or provided with additional burning furnaces to prevent from the liquid from solidifying.

In the hydroelectric generators of the present invention, the water pump can be one of various types of drainage device, such as electric or non-electric turbine type, waterwheel type, spray type, centrifugal fan type, helical mixing type, drag type, man-stirred type, pneumatic type, etc. The water pump can be a water pump, a water pump, suction device, etc. In addition to the electric power, animal labor, the water pump can also be driven by solar energy, wind energy, waterwheel, steam-machine, etc. The drainage speed of the water pump can be adjusted to control the flow speed of the drainage pipe, or the drainage amount of the water pump can be adjusted according to the flow speed of the drainage pipe which is provided with plural sets of hydro-generators, such as one set or more drainage equipments can be provided according to the actual requirements.

In the present device for utilizing water flow kinetic energy continuously, the liquid and water include various liquids such as sea water, river water, mineral water, alkaline water, fresh water, limewater, etc.

In the present device for utilizing water flow kinetic energy continuously, the flumes can be any water containers such as water pipe, water passage, water channel, water tunnel, etc. The flume can be made into various liquid channels such as: 1. The length of the flume can be 1000 meters, less than 1000 meters or more than 1000 meters; 2. The flume can be made with a constant diameter, which can make the same hydro-generators in the flume to generate the same power; 3. If the flume is open, we can monitor the flume at any moment to perform proper control operation, such as if the waterwheel or water pump needs replacement, we can finish the replacement with the shortest time; 4. If the flume is sealed, the flume can be made of transparent material or partially made of transparent material, and the flume can be provided with a liquid injection or drainage control device at any proper position thereof such at the upper head end or lower tail end of the flume, the liquid loss in a combination system consisting of a sealed flume, a sealed water pump, and plural sealed hydro-generators is relatively low; 5. The flume is partially opened or all the flumes are identical different in cross section; 6. The flume is winding to cooperate with various centrifugal helical blade waterwheels to make the hydro-generators to generate power; and 7. The flume can be winding or non-winding and made of various transparent materials or non-transparent materials according to the actual requirements.

In the hydroelectric installation of the present invention, the length of the flume which is installed with the turbines and the hydro-generators exceeds the height difference of the upper head end and lower tail end of the flume, so as to reduce the water load of the water pump when the water pump pumps or discharges water from the lower tail end to the higher upper head end, making the best use of the water flow energy in the different segments of the flumes to make the continuous hydro-generators disposed in every segments of the long flume to generate power more than the power consumed by the water pump.

In the hydroelectric installation of the present invention, the flume disposed between different levels of the tank has a length larger than the length of the drainage pipe employed by the water pump to discharge the water from the lower tail end at the lower level of the tank to the upper head end at the higher level of tank, so that the flume can be provided with a large number of hydro-generators in the respective segments of the flume to generate power which is relatively more than the power consumed by the water pump.

In the hydroelectric installation of the present invention, the height difference between the tank of the upper head end of the flume and the tank of the lower tail end of the flume can be zero.

In the hydroelectric installation of the present invention, when the water pump supplies the water from the tank at the lower tail end of the flume to the upper head end of the flume, the water load of the water pump which is employed to supply water from the water supply to the upper head end of the flume is smaller than a water capacity of the flume which is installed with the hydro-generators.

In the hydroelectric installation of the present invention, the water pump and its related engines can be provided with proper switch controllers according to the actual requirements.

In the hydroelectric installation of the present invention, the water pump disposed in the well at the lower tail end of the flume can use various blades, turbines, centrifugal machines, waterwheels, etc which can be directly used to supply the water in the well at the lower tail end of the flume to the upper head end of the flume.

In the hydroelectric installation of the present invention, the holding flume installed with the water pump, the well space and the water pump are not fixed in size, and they can adjust the drainage speed of the water pump to balance with the drainage volume of the lower tail end of the flume which is provided with plural sets of continuous hydro-generators or various hydro-machineries. The holding flume and the well that are installed with the water pump each can be designed into a ventilating space or a proper space which is not in open air.

In addition to the forms shown in the above drawings, the waterwheels of the present invention can also use various blades such as fan-shaped or windmill-shaped, etc and various turbines centrifugal machines, wipers, pistons, etc.

The flumes, water storage devices of the present invention can be provided with both liquid injection equipments and proper liquid drainage control equipments at proper positions for facilitating liquid feeding and cleaning operations in the flumes.

In addition to the fundamental combinations, the parts of the present invention can also be mixed or used in other ways or can be added with other equipments, as desired. For example, the series of devices of the present invention can not only be controlled in an intelligent, electronic and mechanical manner but can also be controlled by manually operated switches.

The water pump in accordance with the present invention can be powered by its own battery, or external power source or by the power generated from the hydro-generators which generate power by taking use of the water flow caused by the water pump itself.

The water pump in accordance with the present invention can not only work independently but can also be used in various electric equipments or transport means, so that this high energy efficiency can benefit all walks of life and can be used in every article if necessary to derive countless new articles. For example, the electric stoves and various constant temperature devices used in airports or roads, when necessary, can utilize the power generated by the device or method of the present invention to melt snow to prevent causing traffic jam while improving traffic safety.

For the hydro-generator of the present invention, the length of the flume between the upper and lower water tanks is a technique problem which concerns water energy utilization. Under the condition that the amount of water supply is constant, a thick and short flume accommodates less water hydro-generators than a thin and long flume, so the resultant electric power efficiency is also relatively low. Contrarily, if the flume between the upper and lower water tanks is long and thin, it can accommodate more hydro-generators and produce more electric power.

When the water pump draws the water from the lower tail end to the upper head end of the flume, and the lower tail end and the higher head end of the flume are the same in cross section area, the flume can be oblique, winding, rainbow-like, or combination of these. The length of the flume between the upper and lower water tanks is a technique problem which concerns water energy utilization, the longer the flume, the greater the amount of water energy. Water is sufficient, so it also requires a sufficient number of hydro-generators to be arranged at every section of the flume. The more hydro-generators the flume contains, the larger the amount of electric power can be produced. Contrarily, the shorter the flume is, the less hydro-generators it contains, namely, the less electric power can be produced. If increasing the rotation speed of the hydro-generators to prevent the slowdown of the water flow can increase the redundant space of the flume and reduce the number of necessary hydro-generators, it will definitely decrease the water energy utilization of the entire flume while increasing the energy loss of the water pump, and further resulting in a reduction of power energy produced. If the water flow velocity in the flume which has a plurality of hydro-generators arranged in every section thereof is arranged and the water flow velocity in the drainage pipe of the water pump, the length of the drainage pipe of the water pump will affect the energy consumption of the water pump. The longer the drainage pipe of the water pump, the more the energy consumption. Contrarily, the shorter the drainage pipe of the water pump, the less the energy consumption. Under the condition that there is a sufficient number of hydro-generators arranged in every section of the flume, the water energy utilization of the flume is approximately such that the water reserve capacity of the flume by length minus the resistance caused by drawing water from the water source located at the lower tail end of the flume to the well which is located at the upper head end thereof.

In an experiment, we connect two small water tanks with a 0.01-m-diameter and 500 meters long plastic pipe which is obliquely and circularly arranged, the height difference between the water tanks is approximately 0.1 m, and the water pump can be that kind of pump used for goldfish. The experiment is carried out by the following steps: sealing the lower tail end of the pipe with a plastic sheet or user's finger, filling the upper water tank with water until the 500 meters long pipe is full of water; then removing the finger or plastic sheet from the lower tail end of the pipe. At this moment, we can see that a part of the water in the 500 meters long pipe is flowing to the lower water tank, and the whole water of the entire pipe is flowing together. Then a water pump powered by an external power source is turned on to draw the water has flowed from the plastic pipe into the lower water tank back to the upper water tank, so as to make the water flow continuously within the 500-meter-long pipe. During the operation, the power consumption of the water pump, namely the resistance that the water pump encountered, is: 0.1 m×(0.01/2)²×3.14=0.00000785 m³, and the water in the 500-meter-long pipe can be utilized is : 500 m×(0.01/2)²×3.14=0.03925 m³. For example, it can arrange 2000 sets of hydro-generators along the 500-meter-long pipe to produce and output power which is partially supplied to the water pump to make it keep drawing water without using external power source. The 0.03925 m³ water of the 500-meter-long pipe minus the power consumption of the water pump, namely 0.00000785 m³ leaves 0.03924215 m³ water which can be used to generate power by the 2000 sets of hydro-generators, so that the amount of the power generated by the 2000 sets of hydro-generators is much larger than the amount of power consumption of the water pump. This is a highly profitable and sustainable development hydraulic generation technology which is novel, innovative, and practical.

Practice is the sole criterion for testing truth. The oblique 500-meter-long 0.01-diameter pipe that has been filled full of water is the precondition, the water drawn by the water pump is the small amount of water which is discharged from the lower tail end of the pipe and drawn back to replenish the upper head end of the pipe to keep the water flowing naturally down to the lower tail end, which neither increases or reduces the original amount of water in the 500-meter-long pipe, nor requires water pump to move the water within the 500-meter-long pipe, in other words, it doesn't break the law of conservation of energy. This proves that the power consumed by the water pump by drawing the water of the lower tail end of the pipe (which is only a very tiny proportion of the water of the whole pipe) can keep the water within the 500-meter-long pipe running, which can enable the 2000 sets of hydro-generators to produce a much more power than the power consumed by the water pump, and the redundant power can be outputted and supplied to the water pump to keep it working. The water pump and the water within the 500-meter-long pipe have to do work simultaneously on the 2000 hydro-generators which are located at every section of the pipe, both are necessary. In application, although the water flow velocity of the water within the 500-meter-long pipe after the 2000 generators produce power is much reduced as compared with the water flow velocity of the water before after the 2000 generators produce power, it should be balanced by reducing the power consumption of the water pump. Hence, the choose of the size or type of the water pump should depend on the drawing capacity of the lower tail end of the pipe after installation of the hydro-generators and the water level difference between the lower and upper head ends of the pipe.

While we have shown and described various embodiments in accordance with the present invention, it is clear to those skilled in the art that further embodiments may be made without departing from the scope of the present invention.

What is claimed is:

1. A device for utilizing water flow kinetic energy continuously comprising: at least one water pump employed to supply water from a water supply; a flume having a length larger than a distance between the water supply and a upper head end of the flume to which the water is pumped by the water pump; plural continuous hydro-generators disposed on the flume; wherein the pump is used to continuously supply the water from the water supply to the upper head end of the flume and the water will flow from the upper head end of the flume to a lower tail end of the flume, which is lower than the upper head end of the flume, to drive the respective hydro-generators disposed on the flume to generate power, and finally, the water will be supplies to a desired position.

2. A device for utilizing water flow kinetic energy continuously comprising: at least one water pump employed to supply water from a water supply; a flume having a length larger than a distance between the water supply and a upper head end of the flume to which the water is pumped by the water pump; plural continuous hydro-generators disposed on the flume; wherein the pump is used to continuously supply the water from the water supply to the upper head end of the flume and the water will flow from the upper head end of the flume to a lower tail end of the flume, which is lower than the upper head end of the flume, to continuously drive the respective hydro-generators disposed on the flume to generate power or drive other machineries to work, and finally, the water will be supplies to a desired position.

3. The device for utilizing water flow kinetic energy continuously as claimed in claim 2 further comprising a water tank disposed at each of the upper head end and the lower tail end of the flume.

4. The device for utilizing water flow kinetic energy continuously as claimed in claim 2 further comprising: a water pump being disposed at the water tank of the lower tail end of the flume and connecting with another device for utilizing water flow kinetic energy continuously to supply the water from the lower tail end of the flume to a upper head end of a flume of the another device for utilizing water flow kinetic energy to drive respective hydro-generators disposed on the flume of the next device to generate power in the same manner.

5. The device for utilizing water flow kinetic energy continuously as claimed in claim 4, characterized in that plural devices for utilizing water flow kinetic energy are combined in an interlocking multiple manner to supply the water to the desired position.

6. The device for utilizing water flow kinetic energy continuously as claimed in claim 2, characterized in that the lower tail end of the flume is further provided with a water pump to discharge the water back to the upper head end of the flume.

7. The device for utilizing water flow kinetic energy continuously as claimed in claim 2, characterized in that the water pump is powered by an external power supply.

8. The device for utilizing water flow kinetic energy continuously as claimed in claim 2, characterized in that the water pump is powered by the hydro-generators in the flume.

9. The device for utilizing water flow kinetic energy continuously as claimed in claim 2, characterized in that the water pump is powered by both an external power supply and the hydro-generators in the flume.

10. The device for utilizing water flow kinetic energy continuously as claimed in claims 2 to 9, characterized in that the water pumps are driven by an external fuel machinery, wind machinery, solar machinery, animals.

11. The device for utilizing water flow kinetic energy continuously as claimed in claim 2 further comprising an electric temperature constant device for preventing the water in the flume from solidifying.

12. The device for utilizing water flow kinetic energy continuously as claimed claim 2, characterized in that the flume is made of a proper material selected from a group consisting of metal, concrete, plastic, etc, and used independently or by cooperating with various power generation plants and any desired proper environments.

13. A device for utilizing water flow kinetic energy continuously comprising: at least one water pump employed to supply water from a water supply; a flume having a length larger than a distance between the water supply and a upper head end of the flume to which the water is pumped by the water pump; plural continuous hydro-generators disposed on the flume.

14. A device for utilizing water flow kinetic energy continuously comprising: at least one water pump employed to supply water from a lower tail end of a flume to a upper head end of the flume; the flume having a length larger than a distance between a water supply and the upper head end of the flume to which the water is pumped; and plural continuous hydro-generators disposed on the flume; wherein the device for utilizing water flow kinetic energy is used by cooperating with different environments such as water pool, water tank, reservoir, water channel, the sea, etc.

15. The device for utilizing water flow kinetic energy continuously as claimed in claim 14, characterized in that the flume is an oblique circular flume.

16. The device for utilizing water flow kinetic energy continuously as claimed in claim 14, characterized in that the flume is a winding oblique circular flume.

17. The device for utilizing water flow kinetic energy continuously as claimed in claim 14, characterized in that a length of a drainage pipe through which the water is supplied from the lower tail end of the flume to the upper head end of the flume is shorter than the length of the flume provided with the hydro-generators.

18. The device for utilizing water flow kinetic energy continuously as claimed in claim 14, characterized in that the flume is directly installed with the hydro-generators.

19. The device for utilizing water flow kinetic energy continuously as claimed in claim 14, characterized in that the water pump is powered by an external power supply and the hydro-generators in the flume.

20. The device for utilizing water flow kinetic energy continuously as claimed in claim 14, characterized in that the water pump is driven by an external fuel machinery, wind machinery, solar machinery, animals.

21. The device for utilizing water flow kinetic energy continuously as claimed in claim 14 further comprising an electric temperature constant device for preventing the water in the flume from solidifying.

22. The device for utilizing water flow kinetic energy continuously as claimed claim 14, characterized in that the flume is made of a proper material selected from a group consisting of metal, concrete, plastic, etc, and the device is used independently or by cooperating with various power storage equipments and any desired proper environments.

23. A method for utilizing water flow kinetic energy continuously being characterized in that a length of a flume which is installed with hydro-generators is larger than a distance between a water supply and an upper head end of the flume; a water pump is employed to continuously supply water from the water to the upper head end of the flume, and then the water will flow from the upper head end to a lower tail end of the flume to drive plural continuous hydro-generators that are disposed on the flume to generate power, and then the water will be supplied to a desired position, the method is performed by cooperating with a water pool, reservoir, the river channel, the sea, and any other proper environments.

24. A method for utilizing water flow kinetic energy continuously being characterized in that a length of a flume which is installed with hydro-generators is larger than a distance between a water supply and an upper head end of the flume; a water pump is employed to continuously supply water from the water to the upper head end of the flume, and then the water will flow from the upper head end to a lower tail end of the flume to drive plural continuous hydro-generators that are disposed on the flume to generate power or drive machineries to work, and then the water will be supplied to a desired position, the method is performed by cooperating with a water pool, reservoir, the river channel, the sea, and any other proper environments.

25. A method for utilizing water flow kinetic energy continuously being characterized in that at least one water pump is employed to supply water from a lower tail end of a flume to a upper head end of the flume; the flume has a length larger than a distance between a water supply and the upper head end of the flume to which the water is pumped; and plural continuous hydro-generators are disposed on the flume; the method is performed by cooperating with a water pool, reservoir, the river channel, the sea, and any other proper environments.

26. The device for utilizing water flow kinetic energy continuously as claimed in claim 2, wherein a water load of the water pump which is employed to supply water from the water supply to the upper head end of the flume is smaller than a water capacity of the flume which is installed with the hydro-generators.

27. The device for utilizing water flow kinetic energy continuously as claimed in claim 14, wherein a water load of the water pump which is employed to supply water from the water supply to the upper head end of the flume is smaller than a water capacity of the flume which is installed with the hydro-generators.
